(19) United States
(12) Patent Application Publication
(10) Pub. No.: US 2016/0148479 A1
(43) Pub. Date: May 26, 2016

(54) TRACKING ASSEMBLY

(71) Applicant: Darryl G. Harris, SR., Beverly Hills, CA (US)

(72) Inventor: Darryl G. Harris, SR., Beverly Hills, CA (US)

(21) Appl. No.: 14/548,992

(22) Filed: Nov. 20, 2014

(51) Int. Cl. G08B 21/02; A41D 1/00; A41D 11/00; A41D 1/04

(52) U.S. Cl. CPC G08B 21/0269; A41D 1/04; A41D 1/002; A41D 11/00; G08B 21/0288; G08B 21/0283

(57) ABSTRACT

A tracking assembly includes a vest worn by a child. A plurality of light emitters is coupled to the vest to make the child visible to a second user. A processor is coupled to the vest. The processor is electrically coupled to the light emitters. A locator is coupled to the vest. The locator is electrically coupled to the processor to communicate a location of the vest to the processor. A transceiver is coupled to the vest. The transceiver is electrically coupled to the processor. The transceiver is in communication with an external electronic device to notify a second user of the location of the child.

### BACKGROUND OF THE DISCLOSURE

### Field of the Disclosure

The disclosure relates to tracking devices and more particularly pertains to a new tracking device for tracking a location of a child with respect to a guardian.

### SUMMARY OF THE DISCLOSURE

An embodiment of the disclosure meets the needs presented above by generally comprising a vest worn by a child. A plurality of light emitters is coupled to the vest to make the enhance visibility of the child to an observer. A processor is coupled to the vest. The processor is electrically coupled to the light emitters. A locator is coupled to the vest. The locator is electrically coupled to the processor to communicate a location of the vest to the processor. A transceiver is coupled to the vest. The transceiver is electrically coupled to the processor. The transceiver is in communication with an external electronic device to notify a second user of the location of the child.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of a tracking assembly according to an embodiment of the disclosure.

FIG. 2 is a back view of an embodiment of the disclosure.

FIG. 3 is a front view of an embodiment of the disclosure.

FIG. 4 is a right side view of an embodiment of the disclosure.

FIG. 5 is an in-use view of an embodiment of the disclosure.

FIG. 6 is a schematic view of an embodiment of the disclosure.

### DESCRIPTION OF THE PREFERRED EMBODIMENT

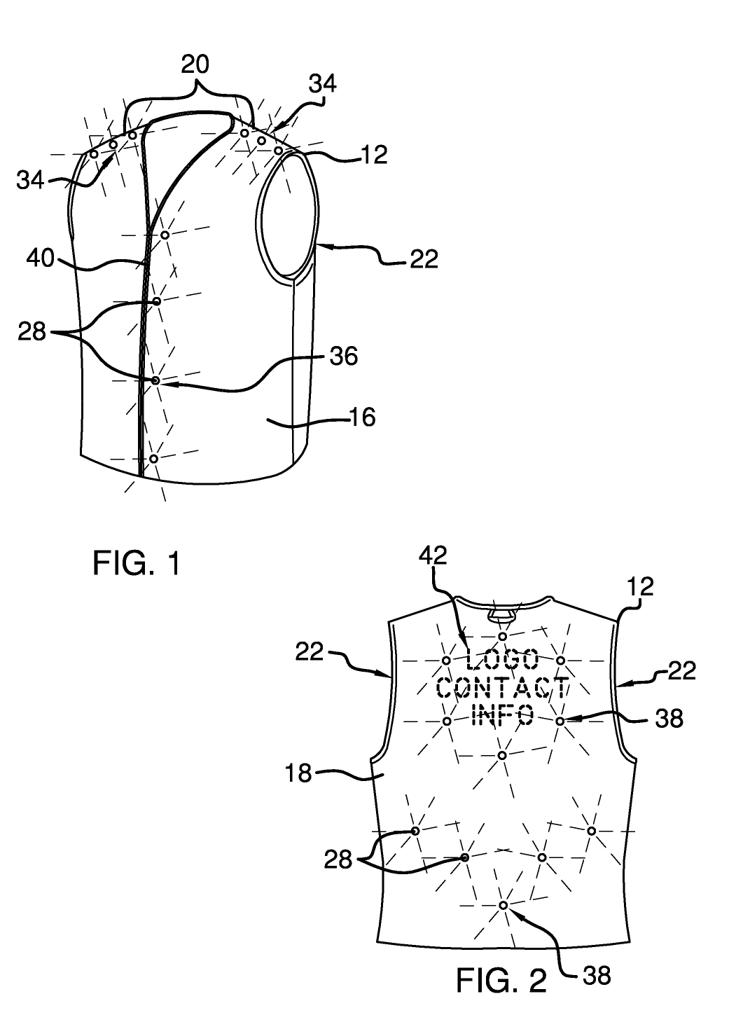

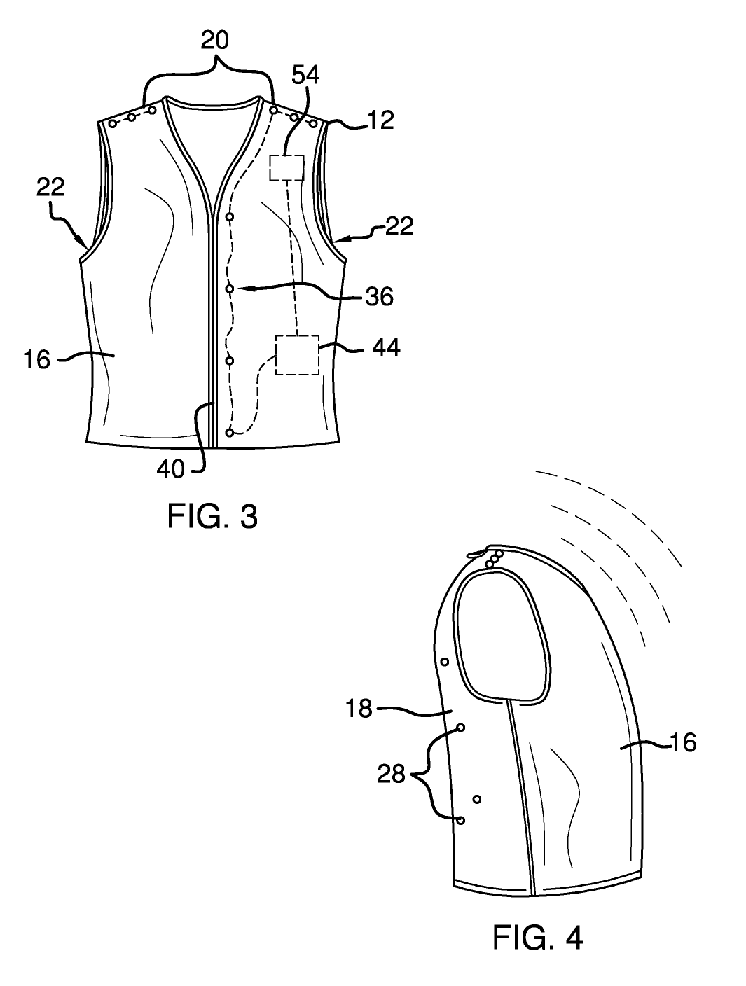

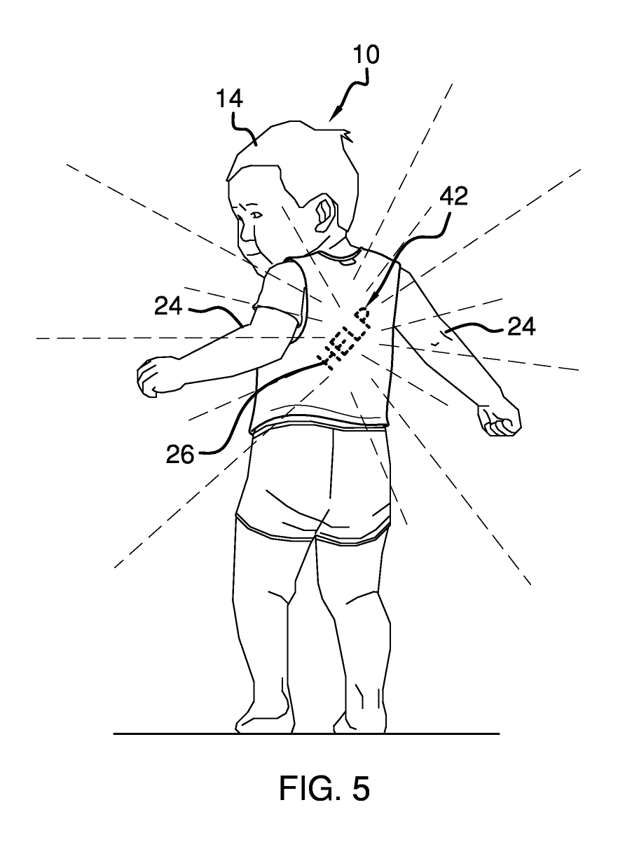

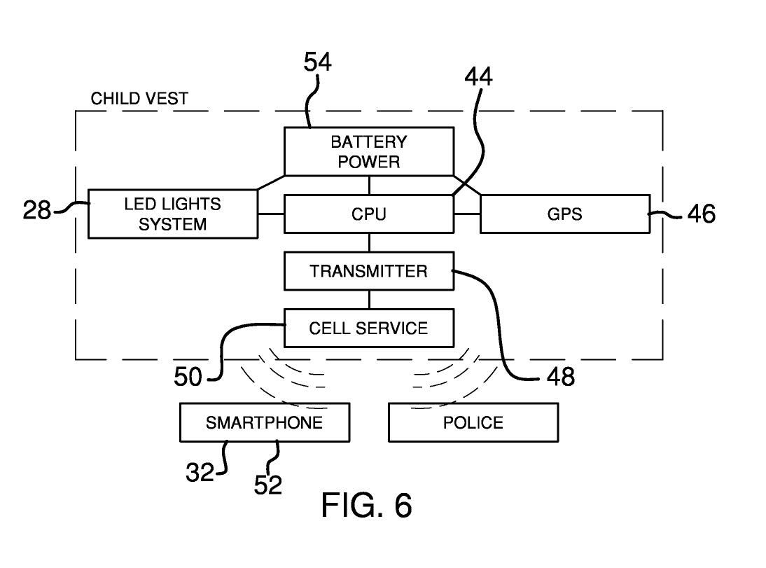

With reference now to the drawings, and in particular to FIGS. 1 through 6 thereof, a new tracking device embodying the principles and concepts of an embodiment of the disclosure and generally designated by the reference numeral 10 will be described.

As best illustrated in FIGS. 1 through 6, the tracking assembly 10 generally comprises a vest 12 worn by a child 14. The child 14 may be a child. The vest 12 is structured to have a front section 16 extending forwardly from a back section 18 to define a pair of shoulders 20 and a pair of arm holes 22 in the vest 12. Each of the child's arms 24 extend through an associated one of the arm holes 22. The front section 16 and the rear section 18 surround the user's torso 26.

A plurality of light emitters 28 is coupled to a respective outer surface 30 of each of the front section 16 and the back section 18 to make the child 14 visible to a second user 32. The second user 32 may be a parent of the child or other guardian. Each of the light emitters 28 may be an LED or the like. The light emitters 28 comprise a first set of light emitters 34, a second set of light emitters 36 and a third set of the light emitters 38.

The first set of light emitters 34 is distributed along each of the pair of shoulders 20. The second set of light emitters 36 is distributed along a button edge 40 of the front section 16. The third set of light emitters 38 is arranged on the back section 18. The back section 18 has indicia 42 printed thereon. The indicia 42 may comprise the child's name and the second user's contact information.

A processor 44 is coupled to the vest 12. The processor 44 is electrically coupled to the light emitters 28. A locator 46 is coupled to the vest 12. The locator 46 is electrically coupled to the processor 44 to communicate a location of the vest 12 to the processor 44. The locator 46 may be a gps or the like.

A transceiver 48 is coupled to the vest 12. The transceiver 48 is electrically coupled to the processor 44. The transceiver 48 is in electromagnetic communication with an external communication network 50. The external communication network may be a cellular phone network or the like. The transceiver 48 notifies local law enforcement that the child has become separated from the second user.

The transceiver 48 is in electromagnetic communication with an external electronic device 52 to communicate of the location of the child 14 to the second user 32. The transceiver 48 may be an RF transceiver or the like. Additionally, the external electronic device 52 may be a smart phone or the like.

A power supply 54 is coupled to the vest 12. The power supply 54 is electrically coupled to the processor 44. The power supply 54 comprises at least one battery 56.

In use, the vest 12 is worn on the child 14 when the child 14 is in a public location. The second user 32 tracks the child 14 with the external electronic device 52. Additionally, the transceiver contacts local law enforcement, notifying them that the child 14 has become lost.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A tracking assembly comprising:
a vest configured to be worn by a child;
a plurality of light emitters coupled to said vest such that said light emitters are configured to make the child visible to a second user;
a processor coupled to said vest, said processor being electrically coupled to said light emitters;
a locator coupled to said vest, said locator being electrically coupled to said processor wherein said locator communicates a location of said vest to said processor; and
a transceiver coupled to said vest, said transceiver being electrically coupled to said processor, said transceiver being in communication with an external electronic device wherein the second user is notified of the location of the child.

2. The assembly according to claim 1, wherein said vest being structured to have a front section extending forwardly from a back section to define a pair of shoulders and a pair of arm holes in said vest, said light emitters being coupled to an outer surface of each of said front section and said back section.

3. The assembly according to claim 2, wherein said light emitters comprising a first set of light emitters, a second set of light emitters and a third set of said light emitters, said first set of light emitters being distributed along each of said pair of shoulders, said second set of light emitters being distributed along a button edge of said front section, said third set of light emitters being arranged on said back section.

4. The assembly according to claim 1, further comprising a power supply coupled to said vest, said power supply being electrically coupled to said processor, said power supply comprising at least one battery.

5. A tracking assembly comprising:
a vest configured to be worn by a child, said vest being structured to have a front section extending forwardly from a back section to define a pair of shoulders and a pair of arm holes in said vest;
a plurality of light emitters coupled to an outer surface of each of said front section and said back section such that said light emitters are configured to make the child visible to a second user;
said light emitters comprising a first set of light emitters, a second set of light emitters and a third set of said light emitters, said first set of light emitters being distributed along each of said pair of shoulders, said second set of light emitters being distributed along a button edge of said front section, said third set of light emitters being arranged on said back section;
a processor coupled to said vest, said processor being electrically coupled to said light emitters;
a locator coupled to said vest, said locator being electrically coupled to said processor wherein said locator communicates a location of said vest to said processor;
a transceiver coupled to said vest, said transceiver being electrically coupled to said processor, said transceiver being in communication with an external electronic device wherein the second user is notified of the location of the child; and
a power supply coupled to said vest, said power supply being electrically coupled to said processor, said power supply comprising at least one battery.
